(19) United States
(12) Patent Application Publication
(10) Pub. No.: US 2011/0197584 A1
(43) Pub. Date: Aug. 18, 2011

(54) BEAM DOWN SYSTEM SOLAR GENERATION DEVICE

(76) Inventors: Kazuaki Ezawa, Tokyo (JP); Hiroo Inoue, Tokyo (JP); Takashi Kawaguchi, Tokyo (JP); Yuzuru Hamada, Osaka (JP)

(21) Appl. No.: 12/809,406

(22) PCT Filed: Dec. 18, 2008
(86) PCT No.: PCT/JP2008/073080

§ 371 Date: Jun. 18, 2010

(30) Foreign Application Priority Data
Dec. 21, 2007 (JP) 2007-330775

(51) Int. Cl. F03G 6/06; F24J 2/18; F24J 2/46; F24J 2/02

(52) U.S. Cl. 60/641.11; 126/680; 126/685

(57) ABSTRACT

Provided is a device for supporting a center reflector stably and firmly. The device improves the setting density of heliostats and is capable of reducing the blocking and the shadowing of the beams of light reflected by the heliostats. In a beam down system solar generation device, the center reflector is attached, in a cantilever manner, to a supporting post standing upright. A pylon is provided to stand on the top of the supporting post. A stay member is attached to the pylon and is used for fixing the center reflector. A second stay member is provided to support the supporting post. This second stay member connects: the pylon; a jut extending out from the back side of the supporting post; and a base.

### TECHNICAL FIELD

The present invention relates to a beam down system solar generation device. More specifically, the present invention relates to a solar generation device which is capable of reducing the occurrence of the blocking and the shadowing of the beams of light reflected by heliostats while improving the setting density of the heliostats and which is also capable of providing a stable and firm support for a center reflector.

### BACKGROUND ART

Recently, there has been an increase in interest in the global environments such as: air pollution caused by exhaust gas produced by the combustion of fossil fuels; and the depletion of fossil fuels. In addition, alternative energy that may replace the aforementioned fossil fuels has attracted more public attention. For such alternative energy, wind power generation and photovoltaic power generation have been spreading.

Meanwhile, there is a concentrating-type solar thermal electric power generation system in which a heat-transfer medium is heated by use of heat produced by concentrating solar rays, steam is produced by the heat of the heat-transfer medium, a steam turbine is driven by the steam, and consequently electric power is generated. The system has attracted public attention because the system can be operated with similar power-generating facilities to those for the conventional thermal power station and can achieve a high output level.

Various types of concentrating-type solar thermal electric power generation systems have been proposed thus far, including a trough-type solar thermal electric power generation system (see, for example, Patent Document 1), a tower-type solar thermal electric power generation system (see, for example, Patent Document 2), and a dish-type solar thermal electric power generation system (see, for example, Patent Document 3). The trough-type system includes: reflectors each having a semi-circular sectional shape and having a light-reflecting surface formed in one surface thereof; and pipes extending in the axial directions of the respective reflectors, and a heat-transfer medium is introduced into the pipes. The tower-type system includes: a tower placed at the center and provided with a heat-transfer-medium heating portion on a top portion thereof; and multiple heliostats placed around the tower. The dish-type system includes: a bowl-shaped reflector having a light-reflecting surface formed in one surface thereof; and a heat-transfer-medium heating portion provided near the reflector.

Meanwhile, the reflector of the trough-type solar thermal electric power generation system has quite a large dimension in the width direction of the reflector. Since the reflectors are installed in lengthwise and widthwise, there is a problem that the trough-type system entails massive-scale installation.

The tower-type solar thermal electric power generation system is capable of increasing the light concentration in a relatively easy way simply by increasing the number of heliostats to be provided. Nevertheless, the tower-type system has its own problems. Firstly, a molten salt is supplied to and is circulated through the heat-transfer-medium heating portion provided on the upper-end side of the tower. Accordingly, there is a problem that, at night when no solar rays are available, the tower-type system must keep the temperature of the molten salt by use of heating means such as an electric heater so as to prevent the molten salt from solidifying. In addition, the piping system for the molten salt becomes so long that the temperature of the molten salt is lowered.

The dish-type solar thermal electric power generation system is a compact-sized system because the heat-transfer medium is heated by collecting the solar rays for each of the reflectors. There is a problem that the dish-type system, however, is not appropriate for massive-scale electric-power generation.

A system known as a beam down system solar generation device has been proposed as a different system from the above-described concentrating-type solar thermal electric power generation systems (see, for example, Non-Patent Document 1).
Patent Document 1: WO2005/017421
Patent Document 2: Japanese patent application Kokai publication No. 2005-106432.
Patent Document 3: Japanese patent application Kokai publication No. 2004-169059.
Non-Patent Document 1: Solar Energy, Volume 62, Number 2, February 1998, pp. 121-129(9)

### DISCLOSURE OF THE INVENTION

### Problems to be Solved by the Invention

As FIG. 5 shows, in the beam down system solar generation device, a disc-shaped center reflector (central reflector mirror) 110 is supported by three supporting posts 100a, 100b and 100c that stand vertically and have a truss structure. No reinforcing members are placed between any two of the supporting posts 100a, 100b and 100c because such reinforcing members cause the blocking and the shadowing to take place. The central reflector mirror 110 has such a large diameter that exceeds 100 m. The central reflector mirror 110 has a long span structure, which is made possible by combining structural pipes (multiple pipes with joint means). The central reflector mirror 110 has such a heavy weight that exceeds 3000 tons.

Accordingly, the supporting posts 100a, 100b, and 100c standing vertically without any reinforcing members provided in between are very vulnerable to the rotary force F in the circumferential direction of the central reflector mirror 110, low resistibility against wind forces and low resistibility against lateral loads at the time of earthquakes. Moreover, the load on each of the supporting posts is large.

In addition, each supporting post is fixed at a fixing portion 112 to the center reflector 110 on the upper-end side and at anchor portions 115a, 115b and 115c on the bottom-end side of the supporting post. Such a structure can provide neither stability nor strength to the supporting posts. Accordingly, there arise problems concerning the safety, the life, and the offsetting of optical axis caused by the distortion or the incorrect positioning of the center reflector 110.

Furthermore, there is another problem. When the number of the supporting posts is increased in order to improve the strength, the blocking and the shadowing may occur, and thus the power generating amount is decreased. For this reason, the strength cannot be improved.

In view of the aforementioned problems that the conventional techniques have, an object of the present invention is to provide a supporting device which is capable of reducing the blocking and the shadowing of the beams of light reflected by the heliostats and which is also capable of fixing firmly and stably a heavy and large-sized center reflector.

### Means for Solving the Problems

A beam down system solar generation device according to the present invention has the following configuration.

1) A solar generation device solar generation device includes: a plurality of heliostats to reflect sunlight; a center reflector to concentrate beams of light reflected by the heliostats on heat-transfer-medium heating means; and steam-turbine electric-power generating means using, as a heat source, a heat-transfer medium heated by the heating means. The solar generation device is characterized in that the center reflector is attached, in a cantilevered manner, to a side of a supporting post standing upright. A pylon stands upright on a top portion of the supporting post, the center reflector is fixed by a stay member attached to the pylon. The supporting post is supported by a stay member connecting the pylon, a jut, and a base, the jut extending from a back-side portion of the supporting post.

As described in the “problem” section given above, in a beam down system solar generation device, the center reflector unit, which has a larger diameter and which is quite heavy, has to be suspended in the air. In addition, a space has to be secured below the center reflector so that the space can be used to place a receiver to collect the heat produced by concentrating the sunlight. The beam down system solar generation device of the present invention is characterized in the following points. A basically vertical center post is placed at a position on a side so that the post is least likely to block the sunlight. The center reflector is provided in a suspended manner on a side so that light beams can be concentrated most efficiently.

The center-reflector placement method according to claim 1 is characterized in the following points. The jut extends towards the opposite side of the center post to the side where the center reflector is provided. The jut is provided by taking account of the weight of the center reflector so as to balance the center reflector provided on the one side.

2) The solar generation device is characterized in that the heliostats are distributed more densely at the northern side of the supporting post than at the southern side thereof.

3) A solar generation device includes: a plurality of heliostats to reflect sunlight; a center reflector to concentrate beams of light reflected by the heliostats on heat-transfer-medium heating means; and steam-turbine electric-power generating means using, as a heat source, a heat-transfer medium heated by the heating means. The solar generation device is characterized in that the center reflector is provided, in a cantilevered manner, to each of both sides of supporting post standing upright.

The center-reflector placement method according to claim 3 is provided to solve the following problem that the conventional method has. According to the conventional method, if more heliostats are provided to achieve higher light-beam concentration efficiency in the sunlight concentrating field, the distance from the center supporting post to the center reflector becomes longer. The method according to claim 3 is characterized in the following points. Another center reflector is provided so as to be opposed to the one center reflector. With the other center reflector, weights balanced on the left and right sides are applied on the center supporting post. Accordingly, the loads on the supporting post can be alleviated while an improvement can be achieved in concentrating the sunlight.

4) The solar generation device is characterized in that the heliostats are distributed more densely at the northern side of the supporting post than at the southern side thereof.

### Effects of the Invention

1) The erecting means is provided to support the supporting post and the hanger means is provided to support the center reflector. These means allow the supporting post to overlap less the optical axes from the heliostats to the center reflector than in the case of a system with a tilting supporting post. Accordingly, such phenomena as the blocking and the shadowing of the beams of light reflected by the heliostats are less likely to take place than in the case of the system with a tilting supporting post.

For this reason, more center reflectors can be provided, so that more beams of light can be concentrated and the electric power can be generated more efficiently.

2) The providing of the plural center reflectors allows the heliostats to be provided still more densely.

In addition, the distance between the plural heat-transfer-medium heating means that are provided respectively below the plural center reflectors can be shortened to a minimum distance. Accordingly, the length of the piping for the heat-transfer medium can be made the shortest. Consequently, the amount of heat dissipated while the heat-transfer medium is being transported can be reduced to the minimum level.

3) The center reflectors provided so as to be opposed to each other equilibrates the balance between the sides of the supporting post. The loads on the supporting post are alleviated. Accordingly, the supporting post can be more quake-resistant and stronger. The fixing of the center reflector can be done more accurately, so that the offsetting of the optical axes can be avoided.
4) In addition, more heliostats are provided more densely at the northern side that is irradiated with more sunlight. Accordingly, the amount of concentrated light beams can be increased further, and the amount of electric-power can be increased as well.

### BRIEF DESCRIPTION OF THE DRAWINGS

FIG. 1 is a schematic view of a center reflector supporting device according to the present invention.

FIG. 2 is a plan view of a center reflector according to the present invention.

FIG. 3 is a schematic view showing a second embodiment of the center reflector according to the present invention.

FIG. 4 is a plan view showing a second embodiment of the center reflector according to the present invention.

FIG. 5 is a view showing a conventional center reflector supporting device.

### DESCRIPTION OF SYMBOLS

A solar generation device
1 supporting post
2 base
4 horizontal beam
5 center reflector
7 stay member
8 pylon
9 jut
12 heating means
14 heliostat

### BEST MODES FOR CARRYING OUT THE INVENTION

Hereinafter, a center-reflector supporting device provided in a beam down system solar generation device according to the present invention will be described by illustrating various embodiments of the present invention.

### (Outline of Beam Down System Solar Generation Device)

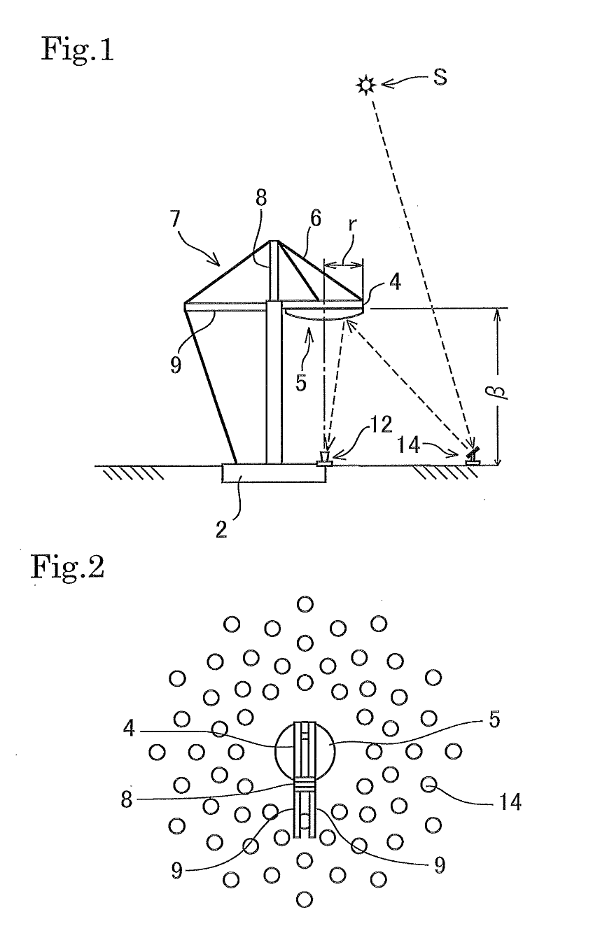

FIG. 1 is a schematic configuration view illustrating a beam down system solar generation device including a supporting device A for a center reflector 5 according to the present invention. As these FIGS. 1 and 2 show, there are arranged a disc-shaped center reflector 5 supported by the supporting device A for the center reflector 5 according to the present invention, at the center of the supporting device A; and multiple heliostats 14 placed so as to surround the center reflector 5. A receiver 12 is provided on the ground at a position located on the center axis of the center reflector 5. The receiver 12 has a funnel shape, and receives the sunlight reflected by the center reflector 5. The receiver 12 includes a molten-salt furnace that heats and melts a heat-transfer medium such as a molten salt. In addition, though not illustrated, electric-power generating facilities including a steam generator, a steam turbine, and the like are provided to generate electric power.

### Embodiment 1

As FIG. 1 shows, the solar generation device A includes the center reflector 5 attached in a cantilevered manner to a side of a supporting post 1 standing upright. A pylon 8 is provided so as to stand on the top of the supporting post 5. A stay member 7 is attached to the pylon 8 to fix the center reflector 5. A stay member 7 connects: the pylon 8; a jut 9 that extends out from the back side of the supporting post 1; and a base 2, and thereby supports the supporting post 1.

In addition, as FIG. 2 shows, the multiple heliostats 14 are concentrically arranged around the supporting post 1 to which the center reflector 5 is attached in a cantilevered manner. The heliostats 14 are distributed more densely at the northern side of the supporting post 1 than at the southern side thereof.

In the solar generation device A with the above-described configuration, the multiple heliostats 14 reflect the sunlight, and then the center reflector 5 reflects the beams of light reflected by the heliostats 14. The beams of light reflected by the center reflector 5 are concentrated on heat-transfer-medium heating means 12. The temperature of the heat-transfer-medium heating means 12 is so high as to be close to 1000° C.

In addition, the heat-transfer medium is a molten salt of, for example, a compound including a metal cation that forms an alkali, a non-metal ion that forms an acid, and the like. During the night, when no sunlight is available, the heat accumulated by the molten salt is used for electric-power generation.

### Embodiment 2

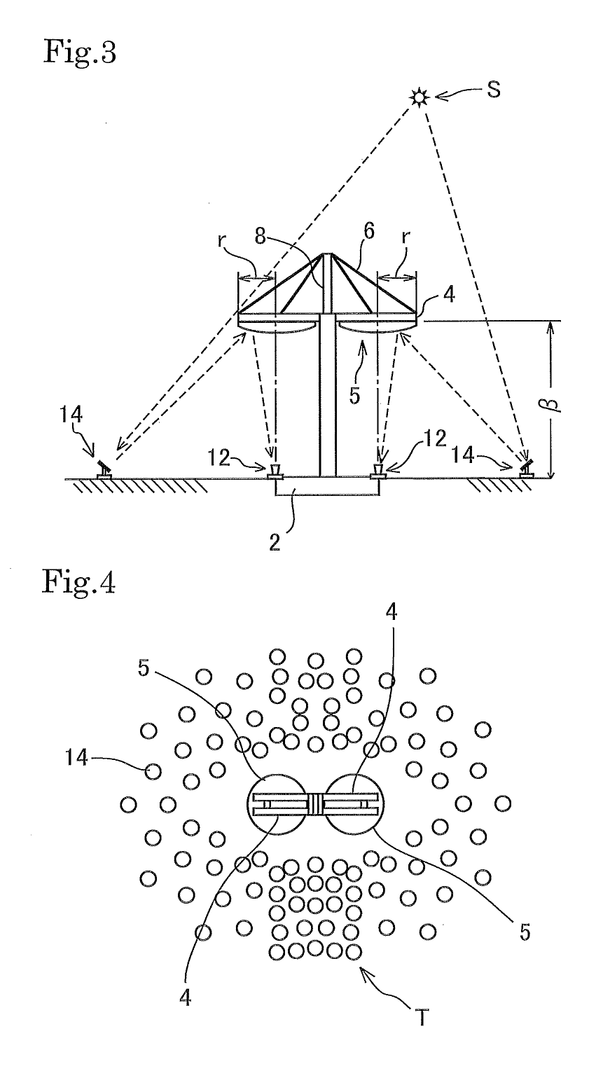

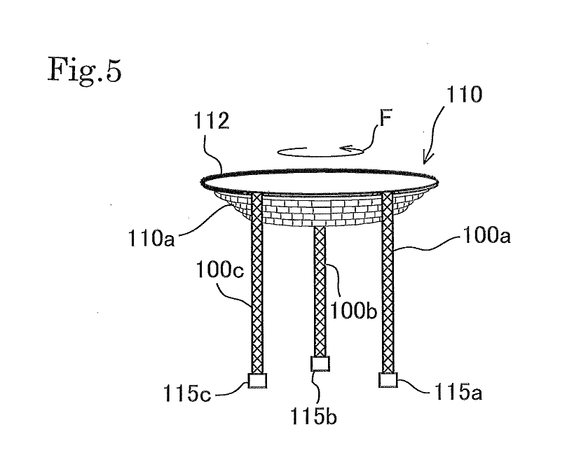

As FIGS. 3 and 4 show, a solar generation device A according to this embodiment includes a central supporting post 1 and two center reflectors 5, 5 attached to the supporting post 1. To be more specific, as FIG. 4 shows, the solar generation device A includes: multiple heliostats 14 that reflect the sunlight; center reflectors 5, 5 that concentrate the beams of light reflected by the heliostats 14 on heat-transfer-medium heating means 12, 12; and steam-turbine electric-power generating means that uses, as the heat source, the heat-transfer medium heated by the heating means 12, 12. The center reflectors 5, 5 are attached respectively to both of the sides of the supporting post 1 in a cantilevered manner.

The heliostats 5, 5 are distributed more densely at the northern side of the supporting post 1 than at the southern side thereof. Such distribution allows the heliostats 14 to reflect the sunlight more efficiently.

What is claimed is:

1. A solar generation device that includes: a plurality of heliostats to reflect sunlight; a center reflector to concentrate beams of light reflected by the heliostats on heat-transfer-medium heating means; and steam-turbine electric-power generating means using, as a heat source, a heat-transfer medium heated by the heating means, the solar generation device characterized in that
the center reflector is attached, in a cantilevered manner, to a side of a supporting post standing upright,
a pylon stands upright on a top portion of the supporting post,
the center reflector is fixed by a stay member attached to the pylon, and
the supporting post is supported by a stay member connecting the pylon, a jut, and a base, the jut extending from a back-side portion of the supporting post.

2. The solar generation device according to claim 1 wherein the heliostats are distributed more densely at the northern side of the supporting post than at the southern side thereof.

3. A solar generation device that includes: a plurality of heliostats to reflect sunlight; a center reflector to concentrate beams of light reflected by the heliostats on heat-transfer-medium heating means; and steam-turbine electric-power generating means using, as a heat source, a heat-transfer medium heated by the heating means, the solar generation device characterized in that
the center reflector is provided, in a cantilevered manner, to each of both sides of supporting post standing upright.

4. The solar generation device according to claim 3 wherein the heliostats are distributed more densely at the northern side of the supporting post than at the southern side thereof.
